(19) United States
(12) Patent Application Publication
(10) Pub. No.: US 2015/0195189 A1
(43) Pub. Date: Jul. 9, 2015

(54) MULTIPLE TREE ROUTED SELECTIVE RANDOMIZED LOAD BALANCING

(71) Applicant: Alcatel Lucent USA, Inc., Murray Hill, NJ (US)

(72) Inventors: Peter J. Winzer, Murray Hill, NJ (US); John E. Simsarian, Piscataway, NJ (US); Andrew B. Feldman, Murray Hill, NJ (US); Thierry E. Klein, Fanwood, NJ (US)

(73) Assignee: Alcatel Lucent USA, Inc., Murray Hill, NJ (US)

(21) Appl. No.: 14/149,263

(22) Filed: Jan. 7, 2014

(51) Int. Cl. H04L 12/733

(52) U.S. Cl. CPC H04L 45/20

(57) ABSTRACT

Various exemplary embodiments relate to a method, network node, and non-transitory machine-readable storage medium including one or more of the following: receiving a message at the network node; selecting a routing tree of a plurality of routing trees based on a plurality of weights associated with the plurality of routing trees; determining a next hop network node for the message based on the selected routing tree; and forwarding the message to the next hop network node.

### TECHNICAL FIELD

Various exemplary embodiments disclosed herein relate generally to network routing and, more particularly but not exclusively, to routing strategy selection in IP/optical networks.

### BACKGROUND

Network service providers are faced with the task of routing client traffic in their network, and aim to achieve this by deploying the fewest number of network interfaces as possible in order to reduce CAPEX and network equipment power consumption while maintaining high reliability and quality of service. The routing strategy selected by the service provider impacts the required number of deployed network interfaces. Many routing strategies exist in today's varied communications networks. For example, a commonly-used routing strategy is shortest-path routing, whereby data packets are routed from source to destination on the shortest number of hops. This strategy can lead to a desirable solution to the placement of interfaces in the network when the node-to-node traffic demands are known in advance. However, when the node-to-node demands are not known, but the ingress/egress traffic is bounded at each node (hose traffic demands), other routing strategies, such as tree-routing allows for lower-cost networks that are robust to the uncertain traffic demands. For example, a network may use single-tree routing wherein network nodes of a system are provided with a routing tree that may be used for hub routing, where all traffic is forwarded through the root node, or for shortest-path routing on the tree, where traffic is routed at each node on the tree. As another example, selective randomized load balancing (SRLB) may be employed, whereby multiple routing trees (each with its own routing hub) are provided to a node that randomly selects different routing trees from the set to route different traffic. Given the vast number of different types of networks, no single strategy appears to be universally optimal; instead, there is a persistent desire to develop new strategies that offer performance improvements in particular networks and under various conditions.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a method performed by a network node for routing messages in a network, the method including: receiving a message at the network node; selecting a routing tree of a plurality of routing trees based on a plurality of weights associated with the plurality of routing trees; determining a next hop network node for the message based on the selected routing tree; and forwarding the message to the next hop network node.

Various embodiments described herein relate to a network node for routing messages in a network, the network node including: a network interface; a memory device configured to store a plurality of routing trees and a plurality of weights; and a processor in communication with the network interface and memory device, the processor being configured to: receive a message via the network interface; select a routing tree of the plurality of routing trees based on the plurality of weights associated with the plurality of routing trees; determine a next hop network node for the message based on the selected routing tree; and forward the message to the next hop network node via the network interface.

Various embodiments described herein relate to a non-transitory machine-readable medium encoded with instructions for execution by a network node for routing messages in a network, the non-transitory machine-readable medium including: instructions for receiving a message at the network node; instructions for selecting a routing tree of a plurality of routing trees based on a plurality of weights associated with the plurality of routing trees; instructions for determining a next hop network node for the message based on the selected routing tree; and instructions for forwarding the message to the next hop network node.

Various embodiments are described wherein selecting a routing tree of a plurality of routing trees based on a plurality of weights associated with the plurality of routing trees includes using at least one of a weighted random selection method and a weighted pseudo-random periodic selection method to select the routing tree.

Various embodiments are described wherein forwarding the message to the next hop network node includes forwarding the message away from a root node of the selected routing tree, wherein the root node is different from the network node. Various embodiments are described wherein forwarding the message to the next hop network node includes forwarding the message on any suitable path within a tree, including a source-root-destination path, and a shortest-path within the tree.

Various embodiments additionally include receiving an additional message; determining that the additional message is associated with deterministic traffic; and forwarding the additional message according to a shortest path routing scheme based on the determination that the additional message is associated with deterministic traffic. Various embodiments identify deterministic traffic based on a tag carried by the message that identifies the message as part of deterministic traffic.

Various embodiments additionally include prior to receiving the message: receiving the plurality of routing trees and the plurality of weights at the network node from a network controller.

Various embodiments additionally include prior to receiving the message, generating the plurality of trees, including: generating a first routing tree; capacitating the first routing tree with at least a first portion of a traffic demand value to create a first plurality of link demands; quantizing the first plurality of link demands; calculating a link cost based on the quantized first plurality of link demands; and determining whether to include the first routing tree in the plurality of routing trees based on the link cost.

Various embodiments are described wherein generating the plurality of trees further includes: generating a second routing tree; capacitating the second routing tree with at least a second portion of a traffic demand value to create a second plurality of link demands; and quantizing the second plurality of link demands, wherein calculating the link cost is further based on the quantized second plurality of link demands, and wherein determining whether to include the first routing tree in the plurality of routing trees based on the link cost includes determining whether to include the first routing tree and second routing tree together in the plurality of routing trees based on the link cost. In various embodiments, the steps of quantizing the first plurality of link demands and quantizing the second plurality of link demands are performed simultaneously by quantizing a combined plurality of link demands created by combining at least the first and second plurality.

Various embodiments are described wherein quantizing the first plurality of link demands includes rounding the first plurality of link demands up based on a multiple of a channel capacity.

Various embodiments described herein relate to a method performed by a network device for configuring a network, the method including: generating a plurality of routing trees; capacitating the plurality of routing trees with at least a portion of a traffic demand to create a plurality of link demands; quantizing the plurality of link demands; calculating a plurality of link costs based on the quantized plurality of link demands; selecting a routing tree from the plurality of routing trees based on the plurality of link costs; and effecting use of the selected routing tree to route messages within the network.

Various embodiments described herein relate to a network device for configuring a network, the network device including: a network interface; a memory device; and a processor in communication with the network interface and memory device, the processor being configured to: generate a plurality of routing trees; capacitate the plurality of routing trees with at least a portion of a traffic demand to create a plurality of link demands; quantize the plurality of link demands; calculate a plurality of link costs based on the quantized plurality of link demands; selecting a routing tree from the plurality of routing trees based on the plurality of link costs; and effect use of the selected routing tree to route messages within the network.

Various embodiments described herein relate to a non-transitory machine-readable storage medium encoded with instructions for execution by a network device for configuring a network, the non-transitory machine-readable storage medium including: instructions for generating a plurality of routing trees; instructions for capacitating the plurality of routing trees with at least a portion of a traffic demand to create a plurality of link demands; instructions for quantizing the plurality of link demands; instructions for calculating a plurality of link costs based on the quantized plurality of link demands; instructions for selecting a routing tree from the plurality of routing trees based on the plurality of link costs; and instructions for effecting use of the selected routing tree to route messages within the network.

Various embodiments are described wherein effecting use of the selected routing tree to route messages within the network includes using the selected routing tree by the network device to route packets within the network.

Various embodiments are described wherein effecting use of the selected routing tree to route messages within the network includes instructing a network node of the network to use the selected routing tree to route messages within the network.

Various embodiments are described wherein quantizing the plurality of link demands includes rounding a link demand of the plurality of link demands up based on a multiple of a channel capacity.

Various embodiments are described wherein rounding a link demand of the plurality of link demands up based on a multiple of a channel capacity includes rounding the link demand up to the next integer number of wavelengths.

Various embodiments are described wherein calculating a plurality of link costs based on the quantized plurality of link demands includes: calculating a link cost based on a first link demand created based on a first capacitated routing tree and a second link demand created based on a second capacitated routing tree.

Various embodiments are described wherein: selecting a routing tree includes selecting a set of routing trees; and effecting use of the selected routing tree to route messages within the network includes effecting use of the selected set of routing trees to route messages within the network.

Various embodiments additionally include generating a plurality of weights associated with the set of routing trees, wherein effecting use of the selected set of routing trees to route messages within the network includes effecting use of the selected set of routing trees together with the plurality of weights to route messages within the network.

### BRIEF DESCRIPTION OF THE DRAWINGS

In order to better understand various exemplary embodiments, reference is made to the accompanying drawings, wherein:

FIG. 1 illustrates an exemplary network for routing messages;

FIG. 2 illustrates an exemplary process for generating a tree set;

FIG. 3 illustrates an exemplary network node;

FIG. 4 illustrates an exemplary network controller;

FIG. 5 illustrates an exemplary hardware diagram for implementing a network node or a network controller;

FIG. 6 illustrates an exemplary data arrangement for storing a tree set;

FIG. 7 illustrates an exemplary method for routing a message using a tree set; and

FIG. 8 illustrates an exemplary method for generating a tree set.

To facilitate understanding, identical reference numerals have been used to designate elements having substantially the same or similar structure or substantially the same or similar function.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., or), unless otherwise indicated (e.g., “or else” or “or in the alternative”). Additionally, the various embodiments described herein are not necessarily mutually exclusive and may be combined to produce additional embodiments that incorporate the principles described herein.

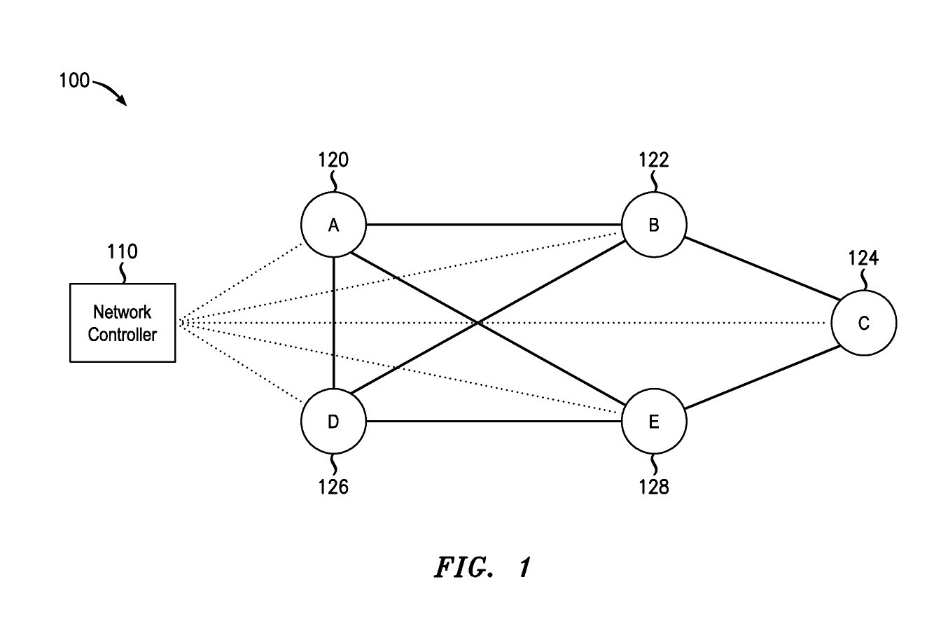

FIG. 1 illustrates an exemplary network 100 for routing messages. In various embodiments, the network 100 is an IP optical network for forwarding packets. As shown, the network 100 includes a network controller 110 and five network nodes 120-128. It will be apparent that the network 100 is merely an example and that the features described herein may be implemented in various other types of networks and in networks of different sizes. For example, various methods described herein may be implemented in an IP/MPLS network including hundreds of network nodes (not shown). Various other environments for implementation of the methods described herein will be apparent.

The network controller 110 is a device configured to coordinate the routing operations of the network nodes 120-128. For example, the network controller 110 may be a software defined networking (SDN) controller and supporting hardware. In some embodiments, the network controller 110 may be supported by hardware resources belonging to a cloud computing environment. The network controller 110 communicates with each of the network nodes 120-128 (or a subset thereof) via one or more networks to provide a routing tree set to be used in forwarding messages within the network 100, as will be described in greater detail below. It will be apparent that the network controller may perform additional functions such as, for example, polling the network nodes 120-128 for or otherwise receiving network state information, routing tree set generation and selection, and receiving and implementing network configurations.

Further, in some alternative embodiments, the network controller 110 may not be present or otherwise may not coordinate the operation of the network nodes 120-128; in some such embodiments, one or more of the network nodes 120-128 may be configured to create and distribute a routing tree set among the remaining network nodes 120-128. For example, network node B 122 may generate and distribute a routing tree set to network node A 120, network node C 124, network node D 126, and network node E 128. As another example, each network node 120-128 may be configured to generate a routing tree set. Various additional modifications will be apparent.

The network nodes 120-128 are devices configured to route messages, such as packets, between each other and other devices external to the network 100. For example, in embodiments where the network 100 is an IP over optical network, the network nodes 120-128 may each be routers with fiber optic interfaces. It will be understood that while the network is illustrated as having direct connections between the network nodes, various intermediate devices, such as switches, may be positioned between adjacent network nodes 120-128 to facilitate communication. For example, the connection between network node A 120 and network node E 128 may traverse three switches that do not participate determining how a message should be routed through the network 100.

In various networks, the capacities of the links between the network nodes 120-128 may be more coarsely quantized than the granularity of the anticipated traffic demands to be placed on the network 100. For example, where the network 100 is an optical network, the links may provide 10 gigabits per second (Gbps) per channel, while traffic demands may be orders of magnitude smaller such as, for example, 100 megabits per second (Mbps). As another example, links may provide 10 Gbps per second per channel, while traffic demands may be anticipated at 10.5 Gbps. As such, two channels would be used for this traffic demand, tying up 20 Gbps of capacity, even though only 10.5 Gbps was actually called for. In such scenarios, existing strategy selection methods may fail to produce optimal results due to the failure to take the difference in granularities into account. Accordingly, as will be described in greater detail below, the network controller 100 in various embodiments quantizes link demands based on the link channel capacities when evaluating the costs associated with multiple potential strategies for implementation within the network.

Further, in various embodiments and as will be described in greater detail below, the network controller 110 provides each network node 120-128 with multiple routing trees and associated weights for use in routing messages. As used herein, the terms “routing tree set” and “tree set” will be understood to encompass this grouping of routing trees and associated weights. According to some embodiments, when receiving a message, a network node 120-128 uses a weighted random selection method for selecting one of the routing trees from the routing tree set. Thereafter, the network node 120-128 uses the selected routing tree to route the message within and potentially back out of the network 100.

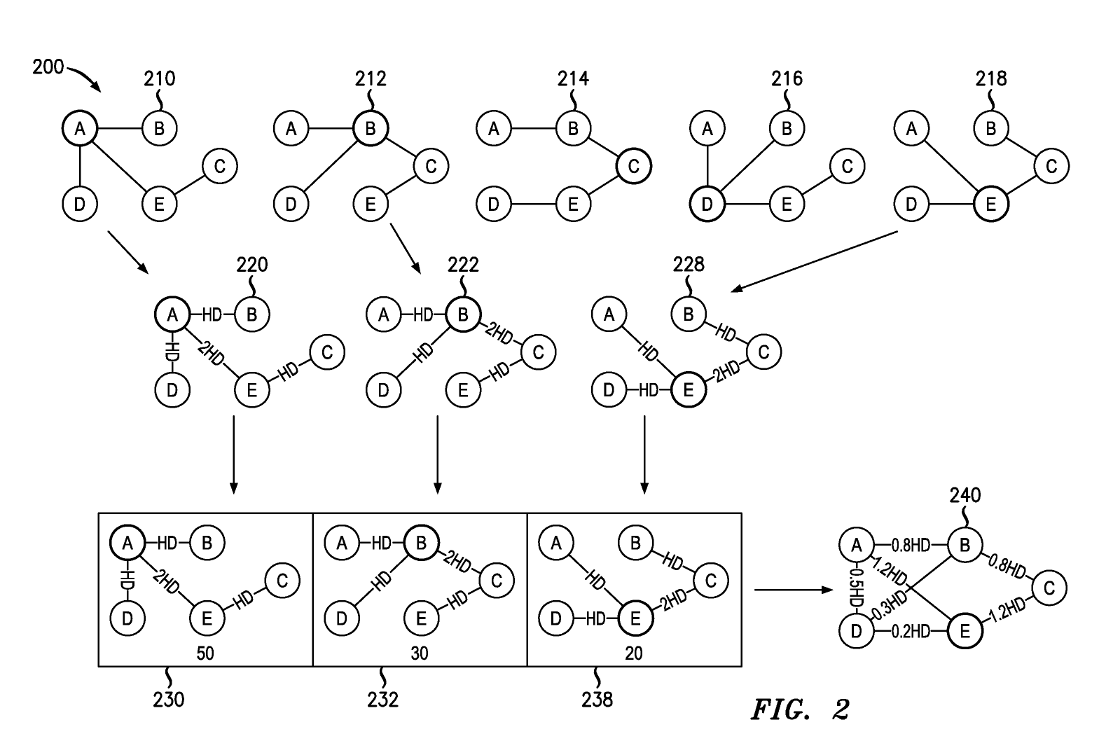

FIG. 2 illustrates an exemplary process 200 for generating a tree set. The process 200 may correspond to the process undertaken by the network controller 110 or one or more network nodes 120-128 when generating a tree set to be used in routing messages within the exemplary network 100. It will be understood that the data structures disclosed herein may be merely illustrative of actual data structures used and processes performed. For example, routing trees may be stored as linked lists while capacities may not actually be stored as part of any data structure and, instead, may only be stored in temporary variables for use in calculating link costs, as will be described below.

The process 200 begins by generating a shortest path (SP) tree 210, 212, 214, 216, 218 for each potential root node 120-128 of the network 100. The SP trees may be generated according to any method such as, for example, Djikstra's algorithm or the Bellman-Ford algorithm.

A subset of the SP trees 210, 212, 218 are then selected and capacitated with the anticipated hose traffic demand (HD) to produce capacitated trees 220, 222, 228. An actual hose traffic demand value may be obtained by any known method such as provisioning of a value by an operator according to the input/output capacity of the nodes, or historical traffic analysis. Due to the uncertain nature of hose traffic, as opposed to deterministic traffic, the trees are capacitated to accommodate all possible hose matrices, including the highest use scenario, where HD traffic is provided to each network node. In the simple example shown in FIG. 2, where all nodes may inject an equal amount of HD that may be destined to any other node or any combination of other nodes without restriction, each link to a leaf node is capacitated with HD demand, while trunk links, such as the link between nodes A and E in the first routing tree 210, are provided with a multiple of the HD demand to accommodate each of the network nodes connected to the trunk.

After capacitating the selected trees 220, 222, 228, weights are assigned to the trees 220, 222, 228 to produce weighted trees 230, 232, 238. These weights may be used in a weighted selection method for influencing how often network nodes use each tree. Together, the weighted trees 230, 232, 238 form a routing tree set that may potentially be used by network nodes 120-128 to route messages within the network 100. To evaluate the sufficiency of the set of weighted trees 230, 232, 238, the trees may be combined into a combined weighted tree 240. In combining the tree, combined link demands are calculated based on the relative weightings of each weighted three 230, 232, 238. For example, the combined link demands for the link between nodes A and E may be calculated as ((50*2HD)+(20*HD))/(50+30+20)=1.2HD. It will be apparent that, in various embodiments, the trees may not actually be combined to produce the combined link demands of the tree set.

Finally, a link cost is calculated from the combined link demands. In an environment where capacity quantization is not considered, the link cost may simply be the sum of the combined link demands: (0.5HD+0.8HD+1.2HD+0.3HD+0.2HD+1.2HD+0.8HD)=5HD. In other environments where capacity quantization is to be considered (such as in IP over optical networks,), each link demand is quantized before summing. For example, a ceiling function may be used to round up based on a multiple of channel capacities such as to the next integer number of channels, wavelengths, or other capacity unit. Following this example, the quantized link cost may be calculated as ([0.5HD]+[0.8HD]+[1.2HD]+[0.3HD]+[0.2HD]+[1.2HD]+[0.8HD]=([0.5HD]+2[0.8HD]+2[1.2HD]+[0.3HD]+[0.2HD]). Where HD is, for example, 15 Gbps and the ceiling function rounds up to the next increment of 10 Gbps, the quantized link cost may be ([0.5*15]+2[0.8*15]+2[1.2*15]+[0.3*15]+[0.2*15])=(10+40+40+10+10)=110 Gbps, while the non-quantized link cost may be (5*15)=75 Gbps. Thus, it can readily be seen that quantization may provide a different and, in some cases, more accurate estimation of the cost of a given routing strategy and thereby may better inform routing strategy selection. As will be described in greater detail below, the total link cost of the network may be compared to other total link costs of the network for different tree sets having different tree combinations or weighting assignments, to determine which of the routing tree sets should be used.

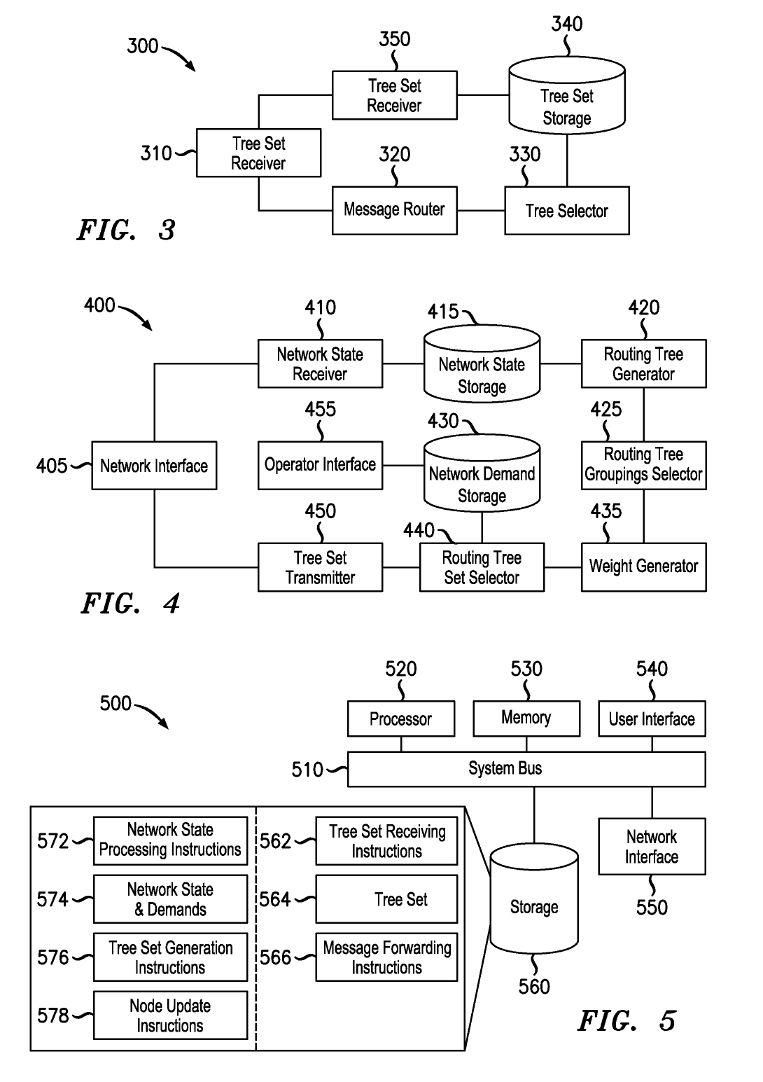

FIG. 3 illustrates an exemplary network node 300. The network node 300 may correspond to one or more of the network nodes 120-128 of the exemplary network 100. It will be understood that exemplary network node 300 as illustrated may be, in some respects, an abstraction. For example, various components are implemented in, or otherwise supported by, hardware that is not illustrated. Exemplary hardware will be described in greater detail below with reference to FIG. 5.

The network node 300 includes a network interface 310 configured to communicate with other devices. The network interface 310 includes hardware or executable instructions on a machine-readable storage medium configured to exchange messages with other devices according to one or more communications protocols. For example, the network interface 310 may include an Ethernet, optical, or IP/MPLS interface. The network interface 310 may implement various other protocol stacks. In various embodiments, the network interface 310 may include multiple physical ports and may support multiple transmission media. For example, the network interface 310 may receive packets via an Ethernet port and forward packets to other network nodes via an optical port. Various other modifications will be apparent.

Upon receiving a message to be routed, the network interface 310 passes the message to a message router 320. The message router 320 includes hardware or executable instructions on a machine-readable storage medium configured to determine, based on a routing table generated based on a routing tree, to where a received message should be forwarded. In various embodiments, upon receiving a message, such as a packet, via the network interface, the message router 320 may first identify a destination of the packet. The destination may be an ultimate destination of the packet or the network node that will serve as an egress from the routing system to which the network device 300 belongs. For example, in the network 100 of FIG. 1, a packet may be transmitted from a source device (not shown) to a destination device (not shown). At some point during transit, the packet may reach network node A 120. Network node A may include an instance of the message router 320 and determine that, for the packet to reach the destination node (not shown), the packet should exit the network 100 at network node C 124. As another example, the packet or other message may be destined for one of the network nodes 120-128. In another embodiment, the message router 320 may first identify a packet's service priority or quality-of-service information as stored in the packet header or as identified through deep-packet inspection. In yet another embodiment, the message router 320 may first identify a packet's identification marker, such as a VLAN tag, an MPLS identifier, or an OTN circuit assignment. In yet another embodiment, specific tree markers may be used and implemented, e.g., through MPLS identifiers, or OTN circuit assignments.

In various embodiments, the message router 320 then requests a routing tree from the tree selector 330 (potentially based on the information extracted from the packet, as explained above), exemplary operation of which will be described below. Upon receiving a routing tree back from the tree selector 330, the message router 320 identifies the next hop to the destination according to the selected tree and subsequently forwards the message to the chosen next hop via the network interface 310. Following the above example, a network router employing the routing tree 210 of FIG. 2 may determine at network node A 120 that, for the packet to reach network node C 124, the packet should next be forwarded to network node E 128. Network node E 128 may then perform a similar process. Alternatively, the ingress node (in this example, network node A 120) may provide the packet with an indication that routing tree 210 should be used, an indication of the full path selected through the network 100, or may otherwise solely determine the path of the message.

The tree selector 330 includes hardware or executable instructions on a machine-readable storage medium configured to, upon request by the message router, select a routing tree from a current routing tree set for use in forwarding a message. In various embodiments, the tree selector 330 may employ a weighted selection method such as, for example, weighted round robin to select a tree from the tree set stored in the tree set storage 340 while also taking into account the weights carried by the tree set. In some such embodiments, the weighted selection method may be a weighted random or periodic pseudo-random (e.g., round-robin) selection method, an example of which will be described in greater detail below with respect to FIG. 7.

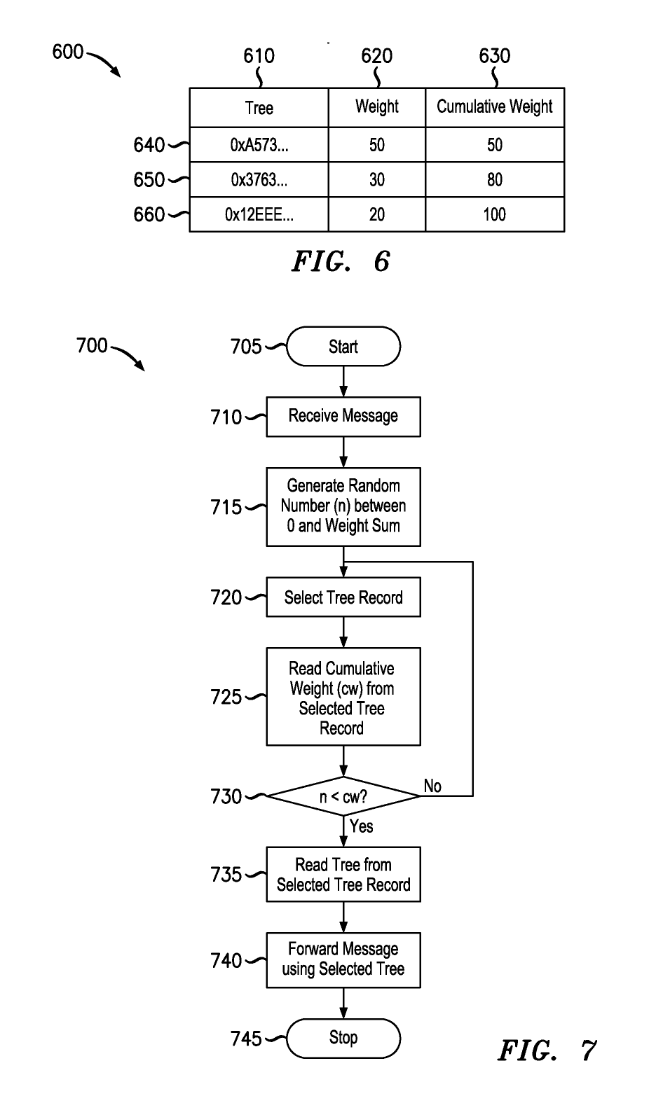

The tree set storage 340 may be any machine-readable medium capable of storing routing trees and associated weight values. Accordingly, the tree set storage 340 may include a machine-readable storage medium such as read-only memory (ROM), random-access memory (RAM), magnetic disk storage media, optical storage media, flash-memory devices, or similar storage media. Exemplary contents for the tree set storage 340 will be described in greater detail below with respect to FIG. 6.

The tree set receiver 350 includes hardware or executable instructions on a machine-readable storage medium configured to receive a tree set from another device via the network interface 310 and store the tree set in the tree set storage 340 for future use by the tree selector 330. In various embodiments, one or more external devices such as a network controller or other network nodes may generate the tree set to be used by the network node 300. Such external device may periodically push a new tree set to the network node 300, upon receipt of which the network update receiver 350 may install the new tree set, potentially overwriting the previous tree set, for use. Alternatively, the tree set receiver 350 may pull new tree sets from a designated external device. In various alternative embodiments, the network node 300 may generate the tree set locally and may include different components instead of the network update receiver 350; for example, the network node 300 may include various components that are similar to components described with regard to the exemplary network controller 400 of FIG. 4 below. Various modification for local tree set generation, evaluation, and selection at a network node 300 will be apparent in view of the present description.

FIG. 4 illustrates an exemplary network controller 400. The network controller 400 may correspond to the network controller 110 of the exemplary network 100. It will be understood that exemplary network controller 400 as illustrated may be, in some respects, an abstraction. For example, various components are implemented in, or otherwise supported by, hardware that is not illustrated. Exemplary hardware will be described in greater detail below with reference to FIG. 5.

The network controller 400 includes a network interface 405 configured to communicate with other devices. The network interface 405 includes hardware or executable instructions on a machine-readable storage medium configured to exchange messages with other devices according to one or more communications protocols. For example, the network interface 405 may include Ethernet, optical, or TCP/IP ports. The network interface 405 may implement various other protocol stacks. In various embodiments, the network interface 405 may include multiple physical ports and may support multiple transmission media. For example, the network interface 405 may receive packets via an Ethernet port and forward packets to other network nodes via an optical port. Various other modifications will be apparent.

The network interface 405 may periodically receive solicited or unsolicited network state updates. Such network state updates are passed to a network state receiver 410 for processing. The network state receiver 410 includes hardware or executable instructions on a machine-readable storage medium configured to interpret or otherwise process received state updates. For example, the network nodes of the system managed by the network controller 400 may periodically report performance statistics, changes in link states, new peer discoveries, or any other information generally useful in tracking the state of the network. Upon receiving such an update, the network state receiver 410 may update a model of the network state stored in a network state storage 415. Such model may be formed according to virtually any useful method.

The network state storage 415 may be any machine-readable medium capable of storing network state information. Accordingly, the network state storage 415 may include a machine-readable storage medium such as read-only memory (ROM), random-access memory (RAM), magnetic disk storage media, optical storage media, flash-memory devices, or similar storage media.

Periodically, the network controller creates tree sets for distribution to and use by network nodes in the managed system. A routing tree generator 420 may periodically (such as on a timed basis, in response to an operator request, or based on changes to the network state) begin this process. Alternatively, in some cases, the network controller 400 may create tree sets once for the life of the network (either manually or automatically) without future modification as, for example, upon network design and installation. The routing tree generator 420 includes hardware or executable instructions on a machine-readable storage medium configured to generate multiple routing trees based on the current network state for potential inclusion in a routing tree set. In some embodiments, the routing tree generator 420 creates a shortest path tree for each potential root network node in the network system. The routing tree generator 420 may use any method for creating the shortest path trees such as, for example, Djikstra's algorithm or the Bellman-Ford algorithm.

After the routing trees have been created, the routing tree generator 420 passes the trees to a routing tree groupings selector 425. The routing tree groupings selector 425 includes hardware or executable instructions on a machine-readable storage medium configured to generate one or more groupings of routing trees for evaluation to include in a tree set. In some embodiments, the routing tree groupings selector 425 generates a group of every possible combination of the generated routing trees. In other embodiments, operator-defined, preconfigured, or other constraints may be placed on the grouping selection such as, for example, minimum and maximum number of trees, maximum tree cost, requirements to use specific trees, or other constraints.

Next, a weight generator 435 creates tree sets for each of the groupings. The weight generator 435 includes hardware or executable instructions on a machine-readable storage medium configured to assign one or more weight sets to each of the groups selected by the routing tree groupings selector 425. For example, the weight generator 435 may generate three tree sets for each of the groupings, wherein the sets differ in the assigned weights. As another example, the weight generator 435 may create only a single tree set for each grouping or may generate an indeterminate number of tree sets whereby the number is determined on a grouping by grouping basis. Various methods for generating potential weight assignments will be apparent. For example, the weight generator 435 may assign preconfigured sets of weights to the trees in various combinations, may generate random weight values, may assign weights proportional to the total link costs of each individual tree, or may algebraically generate desired weights according to other factors. Further, different methods may be employed for different tree sets generated based on a grouping. For example, the weight generator 435 may generate from a single grouping three tree sets with random weightings and two tree sets that have been assigned two different predetermined weightings. Various other modifications will be apparent. The weight generator 435 passes each tree set to the tree set selector 440 for evaluation.

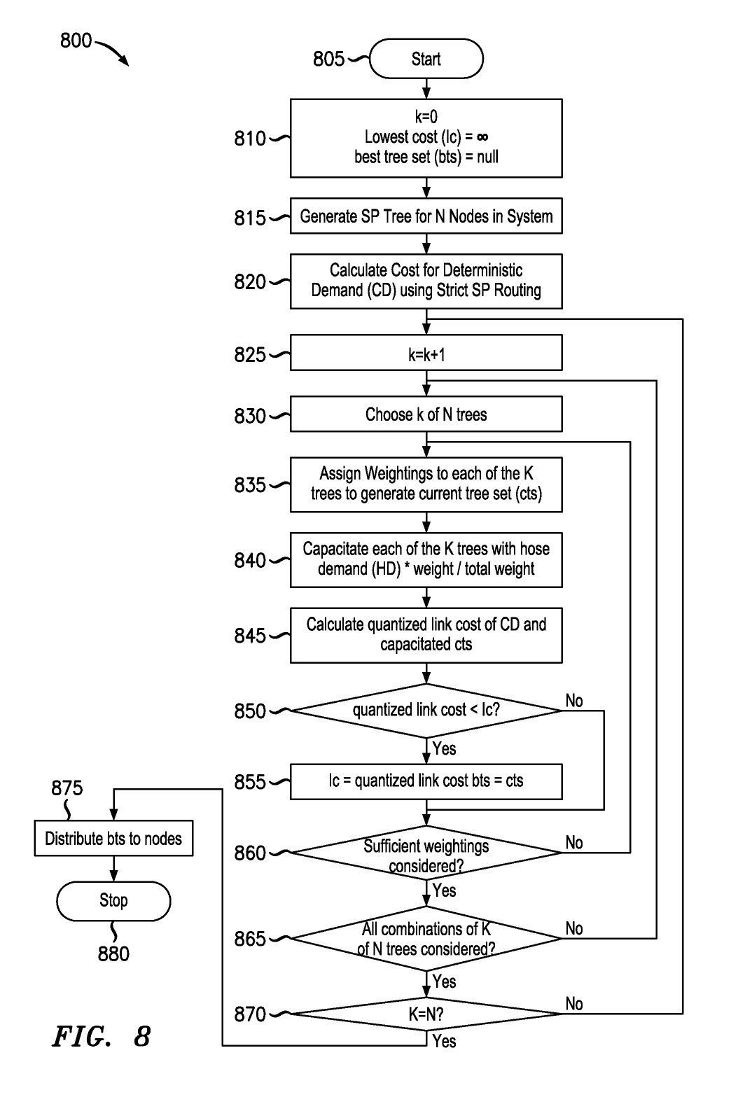

The tree set selector 440 includes hardware or executable instructions on a machine-readable storage medium configured to select one or more tree sets to be used by the network. In some embodiments, the tree set selector 440 selects a single tree set to be used by all network nodes in the system, while in other embodiments the tree set selector 440 selects different tree sets (e.g., tree sets with the same routing trees but different weightings) to be distributed to different network nodes. To evaluate the desirability of each tree set, the tree set selector 440 generates a metric such as total link cost for each tree set, the maximum propagation delay, the maximum delay difference among various trees, or the optimal utilization of network resources in the presence or absence of already existing static or dynamic network traffic.. Various methods for generating a suitable metric will be described in greater detail below with respect to FIG. 8. According to various embodiments, the tree set selector may capacitate the tree sets according to the anticipated hose traffic demand or a hose traffic matrix stored in the network demand storage. Based on the capacitated trees, an estimated link cost is then calculated based on the weights, link demand quantization, or additional deterministic traffic demands. In various embodiments, the tree set selector 440 identifies the lowest cost tree set and passes the selected tree set to the tree set transmitter 450.

The network demand storage 430 may be any machine-readable medium capable of storing statistics such as provisioned, estimated, or observed hose or deterministic traffic demands. Accordingly, the network demand storage 430 may include a machine-readable storage medium such as read-only memory (ROM), random-access memory (RAM), magnetic disk storage media, optical storage media, flash-memory devices, or similar storage media. In various embodiments, the network demand storage 430 and network state storage 415 share a single device.

The tree set transmitter 450 includes hardware or executable instructions on a machine-readable storage medium configured to transmit one or more tree sets selected by the tree set selector 440 to appropriate network nodes via the network interface 405. For example, the tree set transmitter 450 may generate a special packet including an identification of the packet as carrying a tree set for installation as well as a representation of the tree set itself. Various methods for communicating a tree set will be apparent.

An operator interface 455 may also be provided. The operator interface 455 includes hardware or executable instructions on a machine-readable storage medium configured to receive commands from an operator such as, for example, definitions of network traffic demands to be used in evaluating tree sets or instructions to initiate tree set generation. As such, the operator interface 455 may include a mouse, keyboard, or monitor. Alternatively or additionally, the operator interface 455 may share hardware with the network interface 405 such that an operator may remotely issue such commands via a different computer system.

FIG. 5 illustrates an exemplary hardware diagram 500 for implementing a network node or a network controller. The hardware diagram 500 may correspond to the network controller 110 or one or more network nodes 120-128 of the exemplary network 100, the exemplary network node 300, or the exemplary network controller 400. As shown, the hardware device 500 includes a processor 520, memory 530, user interface 540, network interface 550, and storage 560 interconnected via one or more system buses 510. It will be understood that FIG. 5 constitutes, in some respects, an abstraction and that the actual organization of the components of the hardware device 500 may be more complex than illustrated.

The processor 520 may be any hardware device capable of executing instructions stored in memory 530 or storage 560. As such, the processor may include a microprocessor, field programmable gate array (FPGA), application-specific integrated circuit (ASIC), or other similar devices.

The memory 530 may include various memories such as, for example L1, L2, or L3 cache or system memory. As such, the memory 530 may include static random access memory (SRAM), dynamic RAM (DRAM), flash memory, read only memory (ROM), or other similar memory devices.

The user interface 540 may include one or more devices for enabling communication with a user such as an administrator. For example, the user interface 540 may include a display, a mouse, and a keyboard for receiving user commands.

The network interface 550 may include one or more devices for enabling communication with other hardware devices. For example, the network interface 550 may include a network interface card (NIC) configured to communicate according to the Ethernet protocol. Additionally, the network interface 550 may implement a TCP/IP stack for communication according to the TCP/IP protocols. Various alternative or additional hardware or configurations for the network interface 550 will be apparent.

The storage 560 may include one or more machine-readable storage media such as read-only memory (ROM), random-access memory (RAM), magnetic disk storage media, optical storage media, flash-memory devices, or similar storage media. In various embodiments, the storage 560 may store instructions for execution by the processor 520 or data upon with the processor 520 may operate. For example, when the hardware device 500 is a network node, the storage 560 may store tree set receiving instructions 562 for receiving and storing a new tree set 564, as well as message forwarding instructions 566 for selecting a routing tree from the tree set 564 and subsequently forwarding a message. As another example, when the hardware device 500 is a network controller, the storage 560 may store network state processing instructions 570 for receiving and storing information regarding network state and demands 574 as well as instructions for generating and selecting new tree sets 576 and instructions for transmitting new tree sets to appropriate network nodes 578. As noted above, in some embodiments, when the hardware device 500 is a network node, the tree set receiving instructions may be replaced or supplemented by tree set generation instructions 576. Various other modifications will be apparent.

It will be apparent that various information described as stored in the storage 560 may be additionally or alternatively stored in the memory 530. For example, the tree set 564 may be stored, at least partially, in memory 530 for use by the processor 520. In this respect, both the memory 430 and the storage 560 may also be considered to constitute “memory devices.” Various other arrangements will be apparent. Further, the memory 530 and storage 560 may both be considered to be “non-transitory machine-readable media.” As used herein, the term “non-transitory” will be understood to exclude transitory signals but to include all forms of storage, including both volatile and non-volatile memories.

While the hardware device 500 is shown as including one of each described component, the various components may be duplicated in various embodiments. For example, the processor 520 may include multiple microprocessors that are configured to independently execute the methods described herein or are configured to perform steps or subroutines of the methods described herein such that the multiple processors cooperate to achieve the functionality described herein. In some embodiments, such as those wherein the hardware device 500 is implemented in a cloud computing architecture, components may be physically distributed among different devices. For example, the processor 520 may include a first microprocessor in a first data center and a second microprocessor in a second data center. Various other arrangements will be apparent.

FIG. 6 illustrates an exemplary data arrangement 600 for storing a tree set. The data arrangement 600 may correspond to the contents of a tree set storage 340. It will be apparent that the data arrangement 600 may be an abstraction and may be stored in any manner known to those of skill in the art such as, for example, a table, linked list, array, database, or other structure.

The data arrangement 600 includes a tree field 610, weight field 620, and cumulative weight field 630. The tree field 610 stores a representation of a routing tree while the weight field 620 stores a weight value for the associated tree. In various embodiments the tree selection method may be facilitated by use of a cumulative weight value. As such, the cumulative weight field 630 stores a cumulative weight of the associated tree, calculated as the weight plus the cumulative weight of the previous tree.

As an example, tree record 640 stores a tree “0xA573 . . . ” associated with a weight of “50.” Because the tree record 640 is the first record in the data arrangement, the cumulative weight is also “50.” As another example, tree record 650 a tree “0x3763 . . . ” associated with a weight of “30.” The cumulative weight is thus calculated as 50+30=80. The meaning of the remaining tree record 660 will be apparent.

FIG. 7 illustrates an exemplary method 700 for routing a message using a tree set. The method 700 may be performed by a network node such as the network nodes 120-128 of exemplary network 100 or the network node 300.

The exemplary method begins in step 705 and proceeds to step 710 where the network node receives a message. Next, the network node begins the process of employing a weighted random tree selection method by generating a random number between 0 and the top cumulative weight of the tree set currently used by the network node. For example, for the tree set of FIG. 6, the network node generates a random number between 0 and 100. Next, the network node selects the first tree record in step 720 and reads the cumulative weight for the selected tree record in step 725. In step 730, the network node determines whether the random number is less than the cumulative weight. If not, the method 700 loops back to step 720 where the network node selects the next tree record for similar evaluation. Once the network node locates the first-occurring record that carries a higher cumulative weight than the random number, the method 700 proceeds to step 735 where the network node reads the routing tree from the selected record. Then, in step 740, the network node uses the routing tree to forward the message to another device according to various methods, such as those described above. The method 700 then proceeds to end in step 745.

FIG. 8 illustrates an exemplary method 800 for generating a tree set. The method 800 may be performed by a network controller such as the network controller 110 of the exemplary network 100 or the network controller 400. Alternatively, a similar method to method 800 may be performed by a network node such as the network nodes 120-128 of exemplary network 100 or the network node 300. Modifications for effecting tree set generation and selection at the network nodes will be apparent.

The method 800 begins in step 805 and proceeds to step 810 where the device initializes variables that will be used as working values for the method 800. For example, the device initializes a variable “k” to “0,” a lowest cost variable to infinity or another sufficiently high number, and a best tree set to null because no tree sets have been generated or evaluated at this point. Next, in step 815, the device generates a shortest path tree for each of the N nodes in the system. In various embodiments, the method 800 may take into account the cost of deterministic traffic in addition to hose traffic when evaluating tree sets. In some such embodiments, deterministic traffic may be routed according to a different strategy such as, for example, strict shortest path routing on each node. In such embodiments, the device calculates the cost of the deterministic traffic according to the deterministic traffic demand in step 820.

The device then proceeds to evaluate each possible combination of trees with various weightings. It will be understood that alternative methods for selecting tree sets to be evaluated, such as by using various constraints in tree set creation, may be employed. The device first increments the variable k in step 825 and then chooses a combination of k trees. For example, on the first pass where k=1, the device selects a single tree in step 830 for evaluation. Later when k=3, the device selects a combination of three trees in step 830 for evaluation.

Next, in step 835, the device creates a tree set by assigning weights to each of the trees, As noted above, the weights may be assigned in virtually any manner such as, for example, randomly or based on preconfigured weight distribution profiles. The device begins evaluating this tree set in step 840 by capacitating each of the trees with a portion of the hose demand according to the assigned weight. In some embodiments, the device assigns a fraction of hose demand equal to the tree's weight divided by the total weight of the set. For example, for the tree set of FIG. 6, the first tree “0xA573 . . . ” may be capacitated with half of the hose demand, while the second tree “0x3763 . . . ” may be capacitated with 30 percent of the hose demand. Such capacitation may follow the methods disclosed above with respect to FIG. 2.

After capacitating the trees in the current tree set, the device calculates the total link cost of the current tree set. For example, following the methods described with respect to FIG. 2, the device may combine the link demands on each link, including both the hose and deterministic demands, and then quantize the values to create a single total cost value. In step 850, the device determines whether the current tree set is better than previously evaluated tree sets by comparing the link cost to the value of the lowest cost variable. If the current tree set is not an improvement, the method skips ahead to step 860. Otherwise, the device records the new best candidate for routing set to be installed by, in step 855, setting the lowest cost variable equal to the calculated link cost and storing the current tree set in the best tree set variable.

In step 860, the device determines whether a sufficient number of weight distributions have been considered for the current group of trees. For example, the device may ensure that a predetermined number of weight distributions have been considered, that a predetermined set of weight distribution profiles have all been considered, or that a weight set has been sufficiently tuned to provide optimal or otherwise satisfactory results for a given group of trees. If more weightings should be considered, the method loops back to step 835.

After the device is satisfied that enough weightings have been considered, the method 800 proceeds to step 865 where the device determines whether all possible combinations of k trees have been considered. If more combinations remain for consideration, the method 800 loops back to step 830.

After all combinations of k trees have been considered, the method 800 proceeds to step 870, where the device determines whether k=N, meaning that the combination of all trees has just been considered. If not, the method 800 loops back to step 825. Otherwise, the evaluation is complete and the device proceeds to distribute the tree set currently stored in the best tree set variable to the network nodes for installation. The method then proceeds to end in step 880

Various modifications to the method 800 will be apparent. For example, the weightings may not be evaluated and, instead, may be set by, for example, an operator or tuned by the network nodes at runtime. Further, the method 800 may be modified to provide different tree sets, such as different weightings, to different network nodes. As yet another example, the method 800 may be modified to select a best tree set for each value of k.

According to the foregoing, various embodiments provide a new routing scheme and method for configuration thereof. In particular, by quantizing demands when evaluating different routing strategies, the desirability of the routing strategies in various environments may be more accurately estimated. Further, by providing multiple weighted trees to each node in the system, traffic may be more efficiently routed in some networks without the need to route traffic through a single hub node. Various other benefits will be apparent in view of the foregoing.

It should be apparent from the foregoing description that various exemplary embodiments of the invention may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a network node for routing messages in a network, the method comprising:
receiving a message at the network node;
selecting a routing tree of a plurality of routing trees based on a plurality of weights associated with the plurality of routing trees;
determining a next hop network node for the message based on the selected routing tree; and
forwarding the message to the next hop network node.

2. The method of claim 1, wherein selecting a routing tree of a plurality of routing trees based on a plurality of weights associated with the plurality of routing trees comprises at least one of a weighted random selection method and a weighted pseudo-random periodic selection method to select the routing tree.

3. The method of claim 1, wherein forwarding the message to the next hop network node comprises forwarding the message away from a root node of the selected routing tree, wherein the root node is different from the network node.

4. The method of claim 1, further comprising:
receiving an additional message;
determining that the additional message is associated with deterministic traffic; and
forwarding the additional message according to a shortest path routing scheme based on the determination that the additional message is associated with deterministic traffic.

5. The method of claim 1, further comprising, prior to receiving the message:
receiving the plurality of routing trees and the plurality of weights at the network node from a network controller.

6. The method of claim 1, further comprising, prior to receiving the message, generating the plurality of trees, comprising:
generating a first routing tree;
capacitating the first routing tree with at least a first portion of a traffic demand value to create a first plurality of link demands;
quantizing the first plurality of link demands;
calculating a link cost based on the quantized first plurality of link demands; and
determining whether to include the first routing tree in the plurality of routing trees based on the link cost.

7. The method of claim 6, wherein generating the plurality of trees further comprises:
generating a second routing tree;
capacitating the second routing tree with at least a second portion of a traffic demand value to create a second plurality of link demands; and
quantizing the second plurality of link demands,
wherein calculating the link cost is further based on the quantized second plurality of link demands, and
wherein determining whether to include the first routing tree in the plurality of routing trees based on the link cost comprises determining whether to include the first routing tree and second routing tree together in the plurality of routing trees based on the link cost.

8. The method of claim 6, wherein quantizing the first plurality of link demands comprises rounding the first plurality of link demands up based on a multiple of a channel capacity.

9. A network node for routing messages in a network, the network node comprising:
a network interface;
a memory device configured to store a plurality of routing trees and a plurality of weights; and
a processor in communication with the network interface and memory device, the processor being configured to:
receive a message via the network interface;
select a routing tree of the plurality of routing trees based on the plurality of weights associated with the plurality of routing trees;
determine a next hop network node for the message based on the selected routing tree; and
forward the message to the next hop network node via the network interface.

10. The network node of claim 9, wherein, in selecting a routing tree of a plurality of routing trees based on a plurality of weights associated with the plurality of routing trees, the processor is configured to use at least one of a weighted random selection method and a weighted pseudo-random periodic selection method to select the routing tree.

11. The network node of claim 9, wherein, in forwarding the message to the next hop network node, the processor is configured to forward the message away from a root node of the selected routing tree, wherein the root node is different from the network node.

12. The network node of claim 9, wherein the processor is further configured to:
receive an additional message;
determine that the additional message is associated with deterministic traffic; and
forward the additional message according to a shortest path routing scheme based on the determination that the additional message is associated with deterministic traffic.

13. The network node of claim 9, wherein the processor is further configured to, prior to receiving the message:
receive the plurality of routing trees and the plurality of weights at the network node from a network controller.

14. The network node of claim 9, wherein the processor is further configured to, prior to receiving the message, generate the plurality of trees, comprising:
generating a first routing tree;
capacitating the first routing tree with at least a first portion of a traffic demand value to create a first plurality of link demands;
quantizing the first plurality of link demands;
calculating a link cost based on the quantized first plurality of link demands; and
determining whether to include the first routing tree in the plurality of routing trees based on the link cost.

15. The network node of claim 14, wherein, in generating the plurality of trees, the processor is further configured to:
generate a second routing tree;
capacitate the second routing tree with at least a second portion of a traffic demand value to create a second plurality of link demands; and
quantize the second plurality of link demands,
wherein calculating the link cost is further based on the quantized second plurality of link demands, and
wherein, in determining whether to include the first routing tree in the plurality of routing trees based on the link cost, the processor is configured to determine whether to include the first routing tree and second routing tree together in the plurality of routing trees based on the link cost.

16. The network node of claim 14, wherein, in quantizing the first plurality of link demands, the processor is configured to round the first plurality of link demands up based on a multiple of a channel capacity.

17. A non-transitory machine-readable medium encoded with instructions for execution by a network node for routing messages in a network, the non-transitory machine-readable medium comprising:
instructions for receiving a message at the network node;
instructions for selecting a routing tree of a plurality of routing trees based on a plurality of weights associated with the plurality of routing trees;
instructions for determining a next hop network node for the message based on the selected routing tree; and
instructions for forwarding the message to the next hop network node.

18. The non-transitory machine-readable medium of claim 17, wherein the instructions for selecting a routing tree of a plurality of routing trees based on a plurality of weights associated with the plurality of routing trees comprise instructions for using at least one of a weighted random selection method and a weighted pseudo-random periodic selection method to select the routing tree.

19. The non-transitory machine-readable medium of claim 17, wherein the instructions for forwarding the message to the next hop network node comprise instructions for forwarding the message away from a root node of the selected routing tree, wherein the root node is different from the network node.

20. The non-transitory machine-readable medium of claim 17, further comprising:
instructions for receiving an additional message;
instructions for determining that the additional message is associated with deterministic traffic; and
instructions for forwarding the additional message according to a shortest path routing scheme based on the determination that the additional message is associated with deterministic traffic.

21. The non-transitory machine-readable medium of claim 17, further comprising:
instructions for receiving the plurality of routing trees and the plurality of weights at the network node from a network controller.

22. The non-transitory machine-readable medium of claim 17, further comprising instructions for generating the plurality of trees, comprising:
instructions for generating a first routing tree;
instructions for capacitating the first routing tree with at least a first portion of a traffic demand value to create a first plurality of link demands;
instructions for quantizing the first plurality of link demands;
instructions for calculating a link cost based on the quantized first plurality of link demands; and
instructions for determining whether to include the first routing tree in the plurality of routing trees based on the link cost.

23. The non-transitory machine-readable medium of claim 22, wherein the instructions for generating the plurality of trees further comprise:
instructions for generating a second routing tree;
instructions for capacitating the second routing tree with at least a second portion of a traffic demand value to create a second plurality of link demands; and
instructions for quantizing the second plurality of link demands,
wherein the instructions for calculating the link cost are further based on the quantized second plurality of link demands, and
wherein the instructions for determining whether to include the first routing tree in the plurality of routing trees based on the link cost comprise instructions for determining whether to include the first routing tree and second routing tree together in the plurality of routing trees based on the link cost.

24. The non-transitory machine-readable medium of claim 22, wherein the instructions for quantizing the first plurality of link demands comprise instructions for rounding the first plurality of link demands up based on a multiple of a channel capacity.
